(19) United States
(12) Patent Application Publication
(10) Pub. No.: US 2021/0065024 A1
(43) Pub. Date: Mar. 4, 2021

(54) NON-TRANSITORY COMPUTER-READABLE STORAGE MEDIUM FOR STORING DETERMINATION PROCESSING PROGRAM, DETERMINATION PROCESSING METHOD, AND DETERMINATION PROCESSING APPARATUS

(71) Applicant: FUJITSU LIMITED, Kawasaki-shi (JP)

(72) Inventors: Jumma Kudo, Arakawa (JP); Kota Yamakoshi, Ota (JP); Toshihide Miyagi, Kawasaki (JP); Namika Ehara, Nagoya (JP); Daiki Hanawa, Kawasaki (JP)

(73) Assignee: FUJITSU LIMITED, Kawasaki-shi (JP)

(21) Appl. No.: 16/990,437

(22) Filed: Aug. 11, 2020

(30) Foreign Application Priority Data
Aug. 27, 2019 (JP) 2019-155085

(51) Int. Cl. G06N 5/04; G06N 20/20; G06N 5/00

(52) U.S. Cl. CPC G06N 5/04; G06N 5/003; G06N 20/20

(57) ABSTRACT

A non-transitory computer-readable storage medium for storing a determination processing program which causes a processor to perform processing that includes: obtaining an importance degree vector for a plurality of feature amounts by training a first machine learning model based on machine-learning data, the machine-learning data including pieces of training data, each of the pieces of training data including the plurality of feature amounts and being associated with a corresponding determination result; training a second machine learning model of a k-nearest neighbors algorithm in accordance with the machine-learning data and the importance degree vector; and determining, from among the pieces of training data, a piece of data that is similar to data to be predicted, by using the trained second machine learning model and the data to be predicted.

### CROSS-REFERENCE TO RELATED APPLICATION

This application is based upon and claims the benefit of priority of the prior Japanese Patent Application No. 2019-155085, filed on Aug. 27, 2019, the entire contents of which are incorporated herein by reference.

### FIELD

The embodiments discussed herein are related to a non-transitory computer-readable storage medium for storing a determination processing program, a determination processing apparatus, and a determination processing method.

### BACKGROUND

There is a system of assisting patients who are suffering from intractable diseases (hereinafter referred to as “designated intractable disease”) designated based on the intractable disease act and who take great economical burden of medical bills, until effective treatments are established.

For example, a prefectural government officer performs work of comparing application contents of a patient with severity classification and the like and determining whether to approve subsidy for the designated intractable disease, depending on whether a level of the disease of the patient is equal to or higher than a certain level.

In the work of approving subsidy for the designated intractable disease, a current situation is such that persons who have the skill to make appropriate decisions are few with respect to a requested work amount. Such a problem is not a problem limited to the work of approving subsidy for the designated intractable disease and is a problem that may occur also in the case of giving approval for other various application contents.

For the aforementioned situation, there is an attempt to automatically determine whether to approve subsidy or not from data of application contents of a patient by using data analysis with a computer (artificial intelligence or the like).

Although some sort of determination result may be acquired in response to input data by using a computer not only for the approval of subsidy but also for other matters, the grounds of determination result has to be explained.

Examples of the related art include “Explainable artificial Intelligence”, [retrieved Aug. 9, 2019], the Internet <URL:https://en.wikipedia.org/wik/Explainable_artificial_intelligence>.

### SUMMARY

According to an aspect of the embodiments, provided is a non-transitory computer-readable storage medium for storing a determination processing program which causes a processor to perform processing that includes: obtaining an importance degree vector for a plurality of feature amounts by training a first machine learning model based on machine-learning data, the machine-learning data including pieces of training data, each of the pieces of training data including the plurality of feature amounts and being associated with a corresponding determination result; training a second machine learning model of a k-nearest neighbors algorithm in accordance with the machine-learning data and the importance degree vector; and determining, from among the pieces of training data, a piece of data that is similar to data to be predicted, by using the trained second machine learning model and the data to be predicted.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a configuration of a determination processing apparatus according to Embodiment 1;

FIG. 2 illustrates a diagram of an example of a data structure of learning data;

FIG. 3 illustrates a diagram of an example of a data structure of training data;

FIG. 4 illustrates a diagram of an example of a first machine learning model;

FIG. 5 illustrates a diagram of an example of a decision tree;

FIG. 6 illustrates graphs of relationships between a data set D and a data set wD;

FIG. 7 is a flowchart illustrating a processing procedure of the determination processing apparatus according to Embodiment 1;

FIG. 8 is a functional block diagram illustrating a configuration of a determination processing apparatus according to Embodiment 2;

FIG. 9 is a flowchart illustrating a processing procedure of the determination processing apparatus according to Embodiment 2;

FIG. 10 illustrates a graph of relationships between accuracy and understandability of a machine learning model;

FIG. 11 is a functional block diagram illustrating a configuration of a determination processing apparatus according to Embodiment 3;

FIG. 12 is a flowchart illustrating a processing procedure of the determination processing apparatus according to Embodiment 3;

FIG. 13 illustrates a diagram of an example of a hardware configuration of a computer that achieves functions similar to those of the determination processing apparatus;

FIG. 14 is a diagram (1) for explaining a k-nearest neighbors algorithm; and

FIG. 15 is a diagram (2) for explaining the k-nearest neighbors algorithm.

### DESCRIPTION OF EMBODIMENT(S)

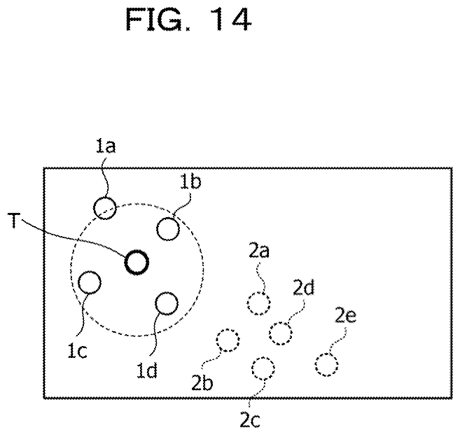

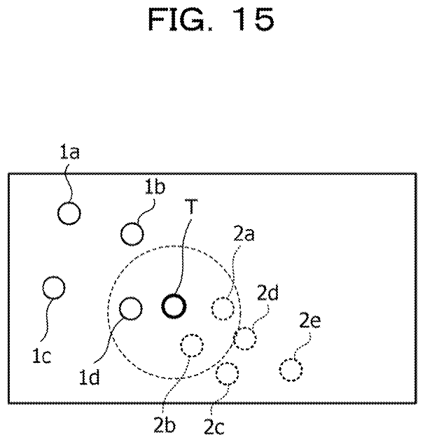

As a method of making determination based on input data, there is a k-nearest neighbors algorithm. FIGS. 14 and 15 are diagrams for explaining the k-nearest neighbors algorithm. In the k-nearest neighbors algorithm, when there are a learning data set D and new data T, k pieces of data nearest to the input data T are selected from the learning data set D to perform determination. In this document, the term “a learning data set” may be referred to as “machine-learning data set”, “a training data set”, and the like.

FIG. 14 is described. The learning data D (may be referred to as “the training data D”, “the sample data D”, and the like) includes pieces of approved data 1a to 1d and pieces of not-approved data 2a to 2e. When k=3, the pieces of approved data 1b to 1d are selected based on the distance to the input data T. Since all pieces of selected data are the pieces of approved data, the input data T is predicted to be “approved data”.

FIG. 15 is described. The learning data D includes pieces of approved data 1a to 1d and pieces of not-approved data 2a to 2e. When k=3, the piece of approved data 1d and the pieces of not-approved data 2a and 2b are selected based on the distance to the input data T. Since the number of pieces of not-approved data is greater than that of the approved data in the pieces of selected data, the input data T is predicted to be “not-approved data”.

As described above, regarding the explainability, the k-nearest neighbors algorithm has such an advantage that data similar to the input data may be presented as the grounds of determination result. For example, in the example described in FIG. 14, the pieces of approved data b to 1d may be presented as the ground of predicting the input data T as the “approved data”. In the example described in FIG. 15, the pieces of not-approved data 2a and 2b may be presented as the ground of predicting the input data T as the “not-approved data”.

As a result of studies made by the inventors, it was found that the accuracy of determination using the k-nearest neighbors algorithm is far from being superior to determination methods using learning models such as random forests and neural network (NN). It is noted that the term “a learning model” may be referred to as “a trained model”.

However, in the determination methods using the learning models (e.g., the trained model) of random forests and NN, it is difficult to preset data similar to the input data together with the determination result. Accordingly, the accuracy and explainability of the determination result has been in a trade-off relationship and it is difficult to achieve high levels in both accuracy and explainability of the determination result.

According to an aspect of the embodiments, provided is a solution to achieve high levels in both accuracy and explainability of the determination result.

Embodiments of a determination processing program, determination processing method, and determination processing apparatus disclosed in the present application are described in detail below with reference to the drawings. Note that present invention is not limited to these embodiments.

### Embodiment 1

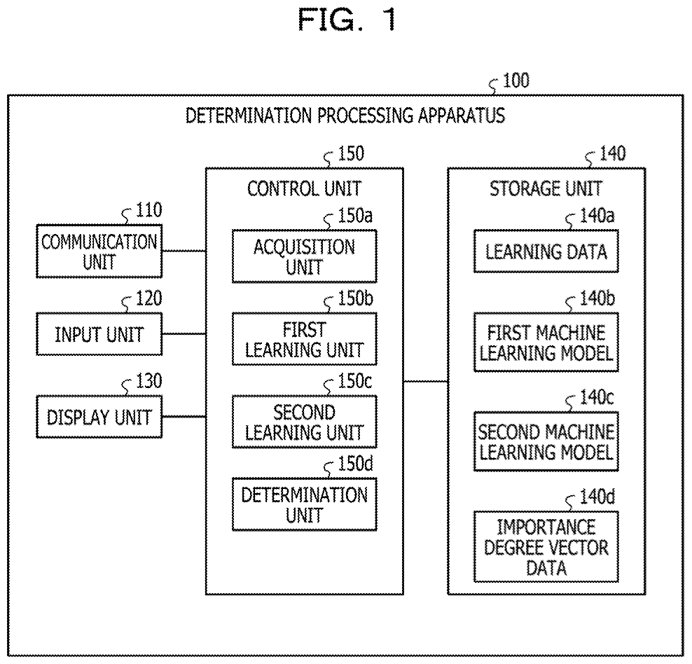

FIG. 1 is a functional block diagram illustrating a configuration of a determination processing apparatus according to Embodiment 1. As illustrated in FIG. 1, the determination processing apparatus 100 includes a communication unit 110, an input unit 120, a display unit 130, a storage unit 140, and a control unit 150.

The communication unit 110 is a processing unit that performs data communication with an external device (not illustrated) via a network. The communication unit 110 is an example of a communication device. The determination processing apparatus 100 may acquire learning data 140a (may be referred to as “machine-learning data 140a”, “training data 140a”, and the like) to be described later from the external device.

The input unit 120 is an input device used to input a variety of information to the determination processing apparatus 100. For example, the input unit 120 corresponds to a keyboard, a mouse, a touch panel, and the like. A user may input data to be predicted by operating the input unit 120. The data to be predicted is described in detail later.

The display unit 130 is a display device that displays information outputted from the control unit 150. For example, the information outputted from the control unit 150 includes information in which a determination result for the data to be predicted is associated with the grounds of the determination result. The display unit 130 corresponds to a liquid crystal display, an organic electro-luminescence (EL) display, a touch panel, or the like.

The storage unit 140 includes the learning data 140a (may be referred to as “machine-learning data 140a”, “the training data 140a”, and the like), a first machine learning model 140b (may be referred to as “a first machine trained model 140b”), a second machine learning model 140c (may be referred to as “a second machine trained model 140c”), and an importance degree vector data 140d. The storage unit 140 corresponds to a semiconductor memory element such as a random-access memory (RAM) and a flash memory, or a storage device such as a hard disk drive (HDD). It is noted that the term “a machine learning model” may be referred to as “a trained model”, “a model”, and the like.

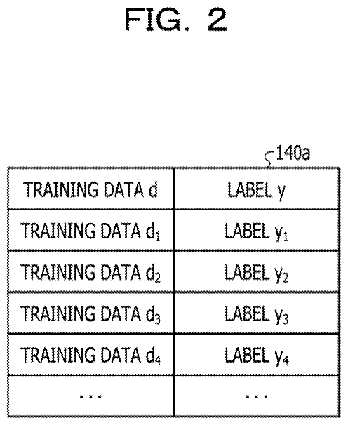

The learning data 140a is data in which pieces of training data are associated with labels. For example, the learning data 140a may include pieces of training data and labels, each of the pieces of training data being associated with a corresponding label from among the labels. In other words, the learning data 140a may include a plurality of pairs of a training data and a label. FIG. 2 illustrates a diagram of an example of a data structure of the learning data. As illustrated in FIG. 2, in the learning data, pieces of training data d are associated with labels y. In this embodiment, as an example, each piece of training data d is assumed to be data on application contents of a patient. Each label y is assumed to a label (ground-truth label) indicating whether the application contents of a patient are recognized as a designated intractable disease or not (recognized or not recognized). A set of pieces of training data d is referred to as “data set D”.

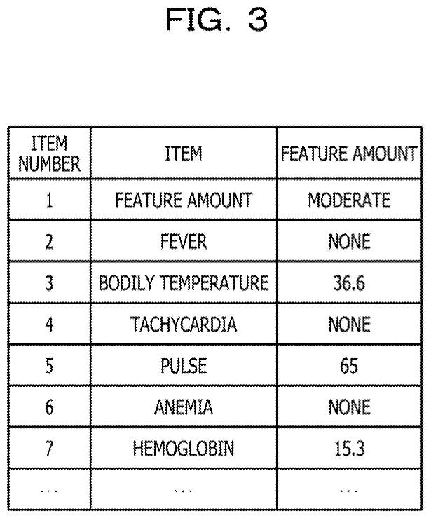

FIG. 3 illustrates a diagram of an example of a data structure of the training data. As illustrated in FIG. 3, in each piece of training data, item numbers, items, and feature amounts are associated with one another. The item numbers are numbers for identifying the items and the feature amounts. The items are items of application contents. The feature amounts are values corresponding to the items.

For example, the items include a severity dassification, fever, bodily temperature, tachycardia, pulse, anemia, hemoglobin, and the like. The feature amount of the item “severity dassification” Is “moderate”, the feature amount of the item “fever” is “none”, the feature amount of the item “bodily temperature” is “36.6”, and the feature amount of the item “tachycardia” is “none”. The feature amount of the item “pulse” is “65”, the feature amount of the item “anemia” is “none”, and the feature amount of the item “hemoglobin” is “15.3”. The items included in the training data correspond to features and the values corresponding to the items correspond to the feature amounts.

The first machine learning model 140b and the second machine learning model 140c to be described later are trained by using a combination of the training data d and the labels y.

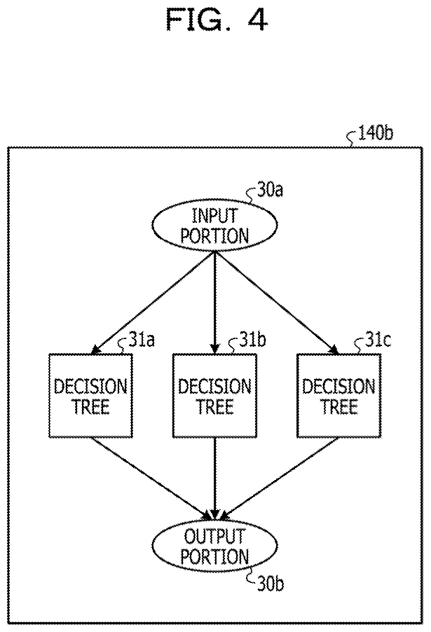

The first machine learning model 140b is a learning model trained by ensemble learning (may be referred to as “ensemble method”). FIG. 4 illustrates a diagram of an example of the first machine learning model. As illustrated in FIG. 4, the first machine learning model 140b Includes an input portion 30a, an output portion 30b, and decision trees 31a, 31b, and 31c. In the embodiment, although the decision trees 31a to 31c are illustrated as an example, the first machine learning model 140b may include other decision trees. In the following description, the decision trees 31a to 31c are collectively referred to as decision trees 31 in the case where they are not particularly distinguished from one another.

The input portion 30a inputs data into the decision trees 31. The data inputted into the decision trees 31 by the input portion 30a includes the training data and the data to be predicted.

The output portion 30b acquires determination results of the decision trees 31 and determines a final determination result to output the final determination result. The output portion 30b may perform majority voting of the determination results outputted from the respective decision trees 31 to determine the final determination result or output confidence factors of the respective determination results.

For example, assume that the decision trees 31 are each a decision tree that determines whether the application contents of a patient are “recognized” or “not recognized” based on the input data. When the outputs of the decision trees 31a and 31b are “recognized” and the output of the decision tree 31c is “not recognized”, the output portion 30b outputs “recognized” as the final determination result. Alternatively, the output portion 30b may output the confidence factor of recognized (2/3) and the confidence factor of not recognized (1/3).

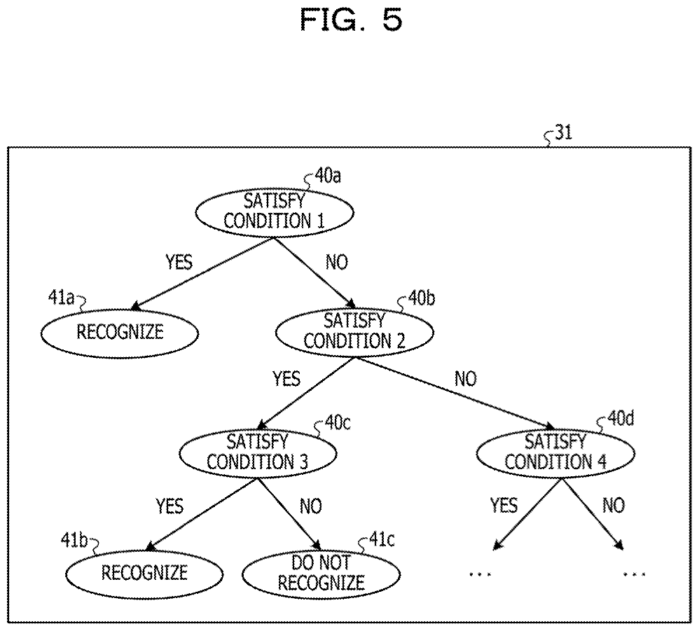

The decision trees 31 are each a decision tree (classification tree) that determines whether the application contents of a patient is “recognized” or “not recognized” based on the data inputted from the input portion 30a. FIG. 5 illustrates a diagram of an example of the decision tree. In the example illustrated in FIG. 5, nodes 40a to 40d and leaves 41a to 41c of the decision tree are illustrated for convenience of description. The decision tree may further include nodes other than the nodes 40a to 40d and leaves other than the leaves 41a to 41e. In the following, description, the nodes 40a to 40d (other nodes) are collectively referred to as “nodes 40”. The leaves 41a to 41e (other leaves) are collectively referred to as “leaves 41”.

The nodes 40 are nodes corresponding to the items in the training data (data to be predicted). A condition vary depending on each item. For example, when the item corresponding to one node 40 is fever, the condition set in the node 40 is a condition branching depending on whether fever is present or absent. When the item corresponding to one node 40 is bodily temperature, the condition set in the node 40 is a condition branching depending on whether a numerical value is equal to or greater than a threshold.

The leaves 41 indicate the determination results. For example, when data is compared with the conditions of the nodes 40 along the decision tree 31 and reaches the leaf 41 of “recognized”, the determination result is “recognized”. When data is compared with the conditions of the nodes 40 along the decision tree 31 and reaches the leaf 41 of “not recognized”, the determination result is “not recognized”.

When the decision tree 31 is trained based on the learning data 140a, an item with a higher importance degree in determination of recognized or not recognized is set in the node 40 in a higher layer. Training the decision tree 31 determines the importance degrees of the respective items (feature amounts of the respective items).

FIG. 1 will be described again. The second machine learning model 140c is a model that outputs a determination result of “recognized” or “not recognized” by using the k-nearest neighbors algorithm. For example, the second machine learning model 140c associates positions of the respective pieces of training data in the learning data 140a that are subjected to weighting, with the labels of the respective pieces of training data. In the following description, the training data subjected to weighting is referred to as “weighted training data”. The weighted training data is described in detail later.

Note that when the feature amount of data (training data, data to be predicted) is not a numerical value, a second learning unit 150c may perform processing with the feature amount changed to a numerical value. For example, the feature amount of fever is “present” or “absent” and processing may be performed with these being “1(present)” or “0 (absent)”.

When the second machine learning model 140c outputs the determination result, the second machine learning model 140c may output the confidence factor of the determination result together with the determination result. For example, assume that k=3 and there are two pieces of training data given the label of “recognized” and one piece of training data given the label of “not recognized” among the pieces of training data nearest to the inputted data. In this case, the second machine learning model 140c outputs the determination result of “recognized” and the confidence factor of “2/3”.

The importance degree vector data 140d indicates the importance degrees of the respective feature amounts included in the data (training data, data to be predicted). The importance degrees of the respective feature amounts are determined in a process of training the first machine learning model 140b. An Importance degree vector w is defined by a formula (1). The importance degree vector w is a vector in which the importance degrees of the respective feature amounts are arranged in the order of the item numbers. The item numbers are numbers for identifying the items and the feature amounts illustrated in FIG. 3.

w=(w₁, . . . ,wₙ) (1)

FIG. 1 will be described again. The control unit 150 includes an acquisition unit 150a, a first learning unit 150b, a second learning unit 150c, and a determination unit 150d. The control unit 150 is achieved by a central processing unit (CPU), a microprocessor unit (MPU), or the like. The control unit 150 may also be achieved by a hard-wired logic circuit such as an application-specific integrated circuit (ASIC) or a field-programmable gate array (FPGA).

The acquisition unit 150a is a processing unit that acquires the learning data 140a from the external device (not illustrated) or the like. The acquisition unit 150a stores the acquired learning data 140a in the storage unit 140. When the acquisition unit 150a acquires the data to be predicted, the acquisition unit 150a outputs the data to be predicted to the determination unit 150d.

The first learning unit 150b is a processing unit that executes the ensemble learning based on the learning data 140a to generate the first machine learning model 140b. When the first machine learning model 140b includes the three decision trees 31a to 31c, the first learning unit 150b divides the learning data 140a into three pieces and learns each of the decision trees 31a to 31c based on a corresponding one of the divided pieces of learning data.

The first learning unit 150b may learn the decision trees 31 by using any algorithm. For example, the first learning unit 150b calculates impurity of a parent node and a child node by using Gini impurity or information entropy. The first learning unit 150b generates each decision tree 31 by repeatedly executing processing of dividing the child node such that a difference between the impurity of the parent node and the impurity of the child node becomes greatest.

When the first learning unit 150b generates the first machine learning model 140b, the first learning unit 150b determines the importance degrees of the respective feature amounts based on the items corresponding to the respective nodes in each decision tree 31 and generates the importance degree vector data 140d. When the importance degree of one feature amount (item) varies among the decision trees 31a to 31c, the first learning unit 150b determines one importance degree based on the varying importance degrees. The first learning unit 150b may select an average of the importance degrees or a median value of the importance degrees.

The second learning unit 150c is a processing unit that generates the second machine learning model 140c based on the learning data 140a. For example, the second learning unit 150c calculates a product “wD” of the importance degree vector w and the data set D of the training data included in the learning data 140a. wD is defined as described in a formula (2). wd in the formula (2) is the weighted training data.

wD=[wd=(w₁d₁, . . . ,wₙdₙ):d∈D] (2)

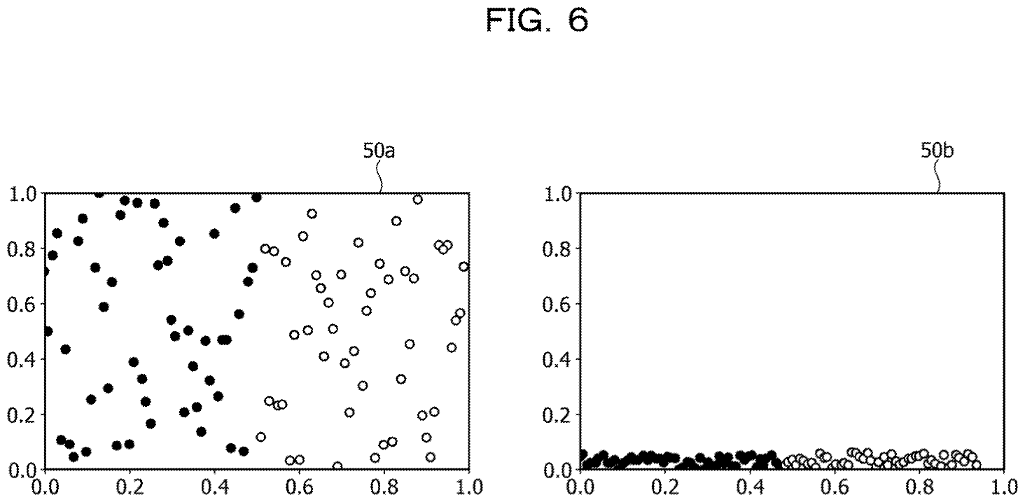

FIG. 6 illustrates graphs of relationships between the data set D and data set wD. In FIG. 6, a graph 50a illustrates a graph of the data set D and a graph 50b illustrates a graph of the data set wD. The horizontal axes of the graphs 50a and 50b are axes corresponding to a first feature amount. The vertical axes of the graphs 50a and 50b are axes corresponding to a second feature amount. For example, the first feature amount and the second feature amount are each a feature amount corresponding to one of the items illustrated in FIG. 3.

For example, assume that the importance degree of the first feature amount is high and the importance degree of the second feature amount is low. In this case, in comparison between the graphs 50a and 50b, differences among pieces of data in the graph 50b in the vertical direction are smaller. Performing the k-nearest neighbors algorithm on the data set wD as illustrated in the graph 50b causes the differences in the feature amount with a low importance degree not to be considered and causes the differences in the feature amount with a high importance degree to be considered and the accuracy of the k-nearest neighbors algorithm is improved.

The second learning unit 150c generates the second machine learning model 140c by associating the positions of the respective pieces of weighted training data with the labels of the respective pieces of training data before the weighting.

The determination unit 150d is a processing unit that predicts the determination result for the data to be predicted. When the determination unit 150d acquires the data to be predicted, the determination unit 150d calculates “weighted data” based on a formula (3). In the formula (3), T is the data to be predicted. w is the importance degree vector described in the formula (1).

T′=w*T (3)

The determination unit 150d acquires the determination result of the k-nearest neighbors algorithm by inputting the weighted data into the second machine learning model 140c. The determination unit 150d determines the training data similar to the weighted data based on the second machine learning model 140c. For example, the determination unit 150d calculates the distance between the weighted data and each piece of weighted training data and sorts the pieces of weighted training data in the ascending order of distance to the weighted data. The determination unit 150d selects k pieces of weighted training data from the top. The determination unit 150d determines the training data before the multiplication of the importance degree vector that corresponds to the selected weighted training data, as the data similar to the data to be predicted. In the following description, the data similar to the data to be predicted is referred to as “similar data”.

The determination unit 150d associates the determination result of the second machine learning model 140c with information being the grounds of determination and outputs the determination result and the information to the display unit 130 to cause it to display the determination result and the information. The information being the grounds of determination is the similar data.

Note that the determination unit 150d may input the data to be predicted into the first machine learning model 140b and acquire the determination result. In this case, the determination unit 150d may associate the determination result of the first machine learning model 140b with information being the grounds of determination and output the determination result and the information to the display unit 130 to cause it to display the determination result and the information. The information being the grounds of determination is the aforementioned similar data.

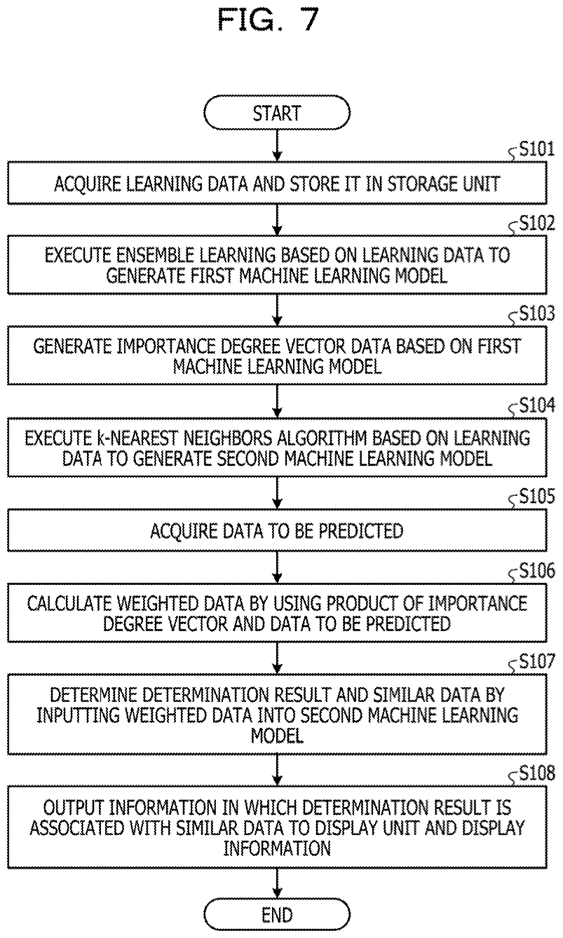

Next, an example of a processing procedure of the determination processing apparatus 100 according to Embodiment 1 is described. FIG. 7 is a flowchart illustrating the processing procedure of the determination processing apparatus according to Embodiment 1. As illustrated in FIG. 7, the acquisition unit 150a of the determination processing apparatus 100 acquires the learning data 140a and stores the learning data 140a in the storage unit 140 (step S101).

The first learning unit 150b of the determination processing apparatus 100 executes the ensemble learning based on the learning data 140a to generate the first machine learning model 140b (step S102). The first learning unit 150b generates the importance degree vector data 140d based on the first machine learning model 140b (step S103).

The second learning unit 150c of the determination processing apparatus 100 executes the k-nearest neighbors algorithm based on the learning data 140a to generate the second machine learning model 140c (step S104). In step S104, the second learning unit 150c generates the second machine learning model 140c by using the product “wD” of the importance degree vector w and the data set D of the learning data 140a.

The acquisition unit 150a of the determination processing apparatus 100 acquires the data to be predicted (step S105). The determination unit 150d of the determination processing apparatus 100 calculates the weighted data by using the product of the importance degree vector and the data to be predicted (step S106).

The determination unit 150d determines the determination result and the similar data by inputting the weighted data into the second machine learning model 140c (step S107). The determination unit 150d outputs the information in which the determination result is associated with the similar data (information being the grounds of the determination result) to the display unit to cause it to display the information (step S108).

Next, effects of the determination processing apparatus 100 according to Embodiment 1 are described. The determination processing apparatus 100 generates the second machine learning model 140c based on the product wD of the importance degree vector and the data set D of the learning data 140a. The determination processing apparatus 100 calculates the weighted data T by using the product of the importance degree vector w and the data to be predicted T. The determination processing apparatus 100 acquires the determination result and the similar data by inputting this weighted data T into the second machine learning model 140c and outputs the similar data as the grounds of the determination result. This causes the differences in the feature amount for the item with a high importance degree to be considered and causes the differences in the feature amount for the item with a low importance degree not to be considered and the determination accuracy of the k-nearest neighbors algorithm is thus improved. Since the explainability of the k-nearest neighbors algorithm is high, high levels may be achieved in both accuracy and explainability of the determination result.

### Embodiment 2

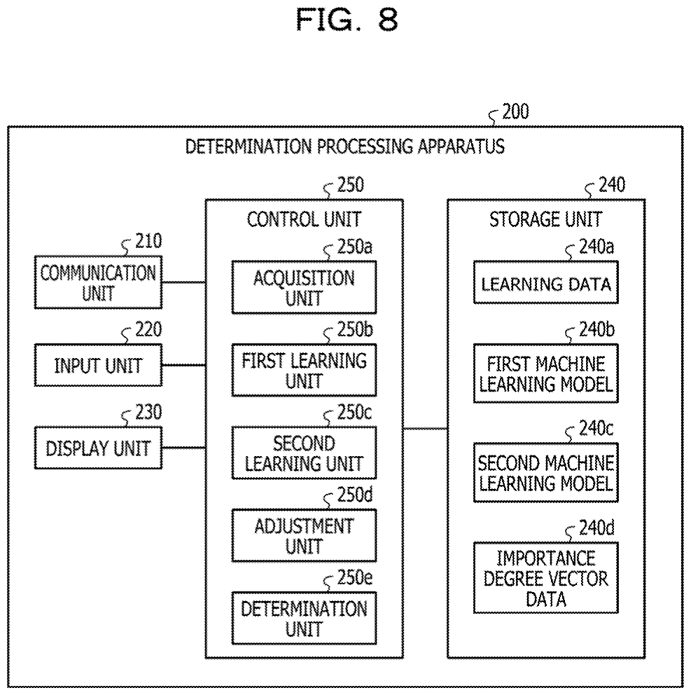

FIG. 8 is a functional block diagram illustrating a configuration of a determination processing apparatus according to Embodiment 2. As illustrated in FIG. 8, the determination processing apparatus 200 includes a communication unit 210, an input unit 220, a display unit 230, a storage unit 240, and a control unit 250.

The communication unit 210 is a processing unit that performs data communication with an external device (not illustrated) via a network. The communication unit 210 is an example of the communication device. The determination processing apparatus 200 may acquire learning data 240a (i.e., machine-learning data) to be described later from the external device.

The input unit 220 is an input device used to input a variety of information to the determination processing apparatus 200. For example, the Input unit 220 corresponds to a keyboard, a mouse, a touch panel, and the like. The user may input the data to be predicted by operating the input unit 220.

The display unit 230 is a display device that displays information outputted from the control unit 250. For example, the information outputted from the control unit 250 includes information in which a determination result for the data to be predicted is associated with the grounds of the determination result. The display unit 230 corresponds to a liquid crystal display, an organic EL display, a touch panel, and the like.

The storage unit 240 includes the learning data 240a, a first machine learning model 240b, a second machine learning model 240c, and an importance degree vector data 240d. The storage unit 240 corresponds to a semiconductor memory element such as a RAM and a flash memory, or a storage device such as an HDD.

The learning data 240a is data in which pieces of training data are associated with labels. A data structure of the learning data 240a is similar to the data structure of the learning data 140a described in FIG. 2 and description thereof is thus omitted. A data structure of the training data is similar to the data structure of the training data described in FIG. 3.

The first machine learning model 240b is a learning model trained by ensemble learning. Description of the first machine learning model 240b is similar to the description of the first machine learning model 140b explained in FIG. 4. The first machine learning model 240b outputs the determination result for the inputted data and the confidence factor of the determination result. The determination result is “recognized” or “not recognized”.

The second machine learning model 240c is a model that outputs the determination result of “recognized” or “not recognized” by using the k-nearest neighbors algorithm. For example, the second machine learning model 240c associates each piece of weighted training data with a corresponding one of the labels of the respective pieces of training data. When the second machine learning model 240c outputs the determination result, the second machine learning model 240c outputs the confidence factor of the determination result together with the determination result.

The importance degree vector data 240d indicates the importance degrees of the respective feature amounts included in the data (training data, data to be predicted). The importance degrees of the respective feature amounts are determined in a process of learning the first machine learning model 240b. The importance degree vector w is defined by the formula (1).

The control unit 250 includes an acquisition unit 250a, a first learning unit 250b, a second learning unit 250c, an adjustment unit 250d, and a determination unit 250e. The control unit 250 may be achieved by a CPU, an MPU, or the like. The control unit 250 may also be achieved by hard-wired logic such as ASIC and FPGA.

The acquisition unit 250a is a processing unit that acquires the learning data 240a from the external device (not illustrated) or the like. The acquisition unit 250a stores the acquired learning data 240a in the storage unit 240. When the acquisition unit 250a acquires the data to be predicted, the acquisition unit 250a outputs the data to be predicted to the determination unit 250e.

The first learning unit 250b is a processing unit that executes the ensemble learning based on the learning data 240a to generate the first machine learning model 240b. When the first machine learning model 240b includes the three decision trees 31a to 31c, the first learning unit 250b divides the learning data 240a into three pieces and learns each of the decision trees 31a to 31c based on a corresponding one of the divided pieces of learning data. The processing of the first learning unit 250b learning the decision trees 31 is similar to that of the first learning unit 150b described in Embodiment 1.

Note that the first learning unit 250b adjusts the importance degree vector w by cooperating with the adjustment unit 250d to be described later.

The second learning unit 250c is a processing unit that generates the second machine learning model 240c based on the learning data 240a. For example, the second learning unit 250c calculates a product “wD” of the importance degree vector w and the data set D of training data included in the learning data 240a. As described in Embodiment 1, wD is defined as in the formula (2).

The second learning unit 250c generates the second machine learning model 240c by associating the positions of the respective pieces of weighted training data with the labels of the respective pieces of training data (before the weighting).

The adjustment unit 250d is a processing unit that adjusts the importance degree vector w based on a determination result acquired when the data set D is inputted into the first machine learning model 240b and a determination result acquired when the product wD of the data set D and the importance degree vector w is inputted into the second machine learning model 240c. The adjustment unit 250d updates the importance degree vector data 240d by using the adjusted importance degree vector w.

The determination result acquired when the data set D is inputted into the first machine learning model 240b corresponds to a first determination result. The determination result acquired when the product wD is inputted into the second machine learning model 240c corresponds to a second determination result. The adjustment unit 250d searches for the importance degree vector w that minimizes a difference between the confidence factor of the first determination result and the confidence factor of the second determination result.

The adjustment unit 250d adjusts the importance degree vector w such that a value of an objective function of a formula (4) is minimized. The formula (4) is a formula in which the difference between M(D) and K(wD) is minimized. The objective function to be minimized is a norm (Frobenius norm) of a matrix.

$${min}_{w ∈ {R}^{a}} {‖ M ( D ) - K ( wD ) ‖}_{F} \qquad ( 4 )$$

In the formula (4), M(D) indicates a matrix of prediction probabilities (confidence factors of the respective labels) outputted when the pieces of training data d included in the data set D are inputted into the first machine learning model 240b.

k(wD) indicates a matrix of prediction probabilities outputted when pieces of training data wd included in the product wD are inputted into the second machine learning model 240c.

For example, the adjustment unit 250d searches for the importance degree vector w that minimizes the objective function of the formula (4) by repeatedly executing processing of updating the importance degree vector w and updating the decision trees 31 of the first machine learning model 240b according to the updated importance degree vector w to acquire the value of the formula (4) while cooperating with the first learning unit 250b. The adjustment unit 250d may use any search method and, for example, may use “hyperopt” that is a black box optimization.

The determination unit 250e is a processing unit that predicts the determination result for the data to be predicted. The determination unit 250e calculates the “weighted data” based on the formula (3) described in Embodiment 1.

The determination unit 250e acquires the determination result of the k-nearest neighbors algorithm by inputting the weighted data into the second machine learning model 240c. The determination unit 250e determines the training data similar to the weighted data based on the second machine learning model 240c. For example, the determination unit 250e calculates the distance between the weighted data and each piece of weighted training data and sorts the pieces of weighted training data in the ascending order of distance to the weighted data. The determination unit 250e selects k pieces of weighted training data from the top. The determination unit 250e determines the training data before the multiplication of the importance degree vector that corresponds to the selected weighted training data, as the data similar to the data to be predicted (similar data).

The determination unit 250e associates the determination result of the second machine learning model 240c with the information being the grounds of determination and outputs the determination result and the information to the display unit 230 to cause it to display the determination result and the information. The information being the grounds of determination is the similar data.

Note that the determination unit 250e may input the data to be predicted into the first machine learning model 240b and acquire the determination result. In this case, the determination unit 250e may associate the determination result of the first machine learning model 240b with the information being the grounds of determination and output the determination result and the information to the display unit 230 to cause it to display the determination result and the information. The information being the grounds of determination is the aforementioned similar data.

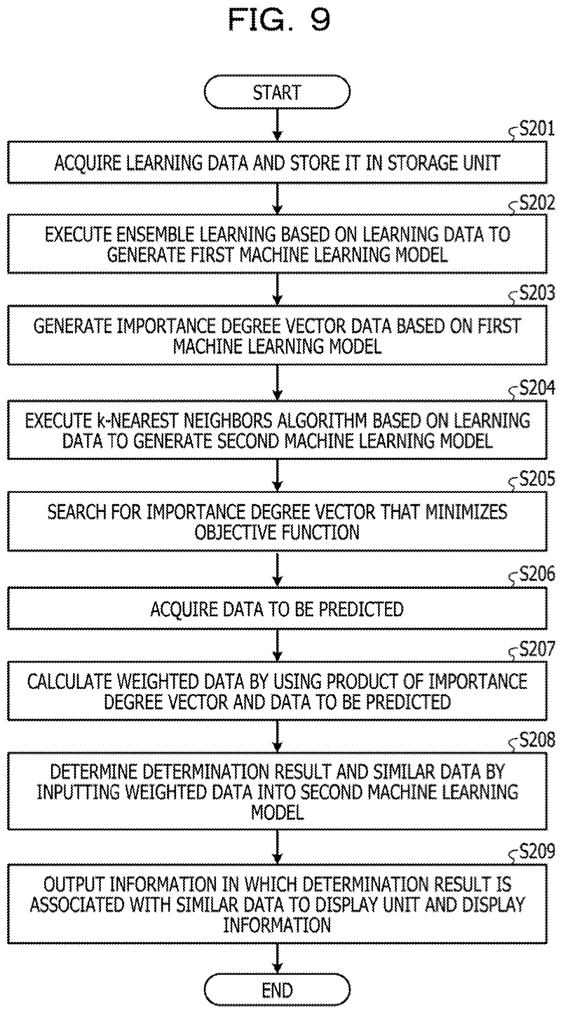

Next, an example of a processing procedure of the determination processing apparatus 200 according to Embodiment 2 is described. FIG. 9 is a flowchart illustrating the processing procedure of the determination processing apparatus according to Embodiment 2. As illustrated in FIG. 9, the acquisition unit 250a of the determination processing apparatus 200 acquires the learning data 240a and stores the learning data 240a In the storage unit 240 (step S201).

The first learning unit 250b of the determination processing apparatus 200 executes the ensemble learning based on the learning data 240a to generate the first machine learning model 240b (step S202). The first learning unit 250b generates the importance degree vector data 240d based on the first machine learning model 240b (step S203).

The second learning unit 250c of the determination processing apparatus 200 executes the k-nearest neighbors algorithm based on the learning data 240a to generate the second machine learning model 240c (step S204). In step S204, the second learning unit 250c generates the second machine learning model 240c by using the product “wD” of the importance degree vector w and the data set D of the learning data 240a.

The adjustment unit 250d of the determination processing apparatus 200 searches for the importance degree vector that minimizes the objective function of the formula (4) (step S205). The acquisition unit 250a acquires the data to be predicted (step S206). The determination unit 250e of the determination processing apparatus 200 calculates the weighted data by using the product of the importance degree vector and the data to be predicted (step S207).

The determination unit 250e determines the determination result and the similar data by inputting the weighted data into the second machine learning model 240c (step S208). The determination unit 250e outputs the information in which the determination result is associated with the similar data (information being the grounds of the determination result) to the display unit 230 to cause it to display the information (step S209).

Next, effects of the determination processing apparatus 200 according to Embodiment 2 are described. The determination processing apparatus 200 searches for the importance degree vector w that minimizes the difference between the confidence factor of the first determination result and the confidence factor of the second determination result. The determination processing apparatus 200 adds weight to the data to be predicted by using the searched importance degree vector w, inputs the weighted data into the second machine learning model 240c, and determines and displays the determination result and the grounds of the determination result. The importance degree vector w determined only by the ensemble learning as described in Embodiment 1 does not necessarily optimally express the importance degree of each feature amount. Meanwhile, in Embodiment 2, the determination processing apparatus 200 searches for the importance degree vector w that minimizes the objective function described in the formula (4) and this allows the importance degree of each feature amount to be suitably acquired and improves the determination accuracy.

### Embodiment 3

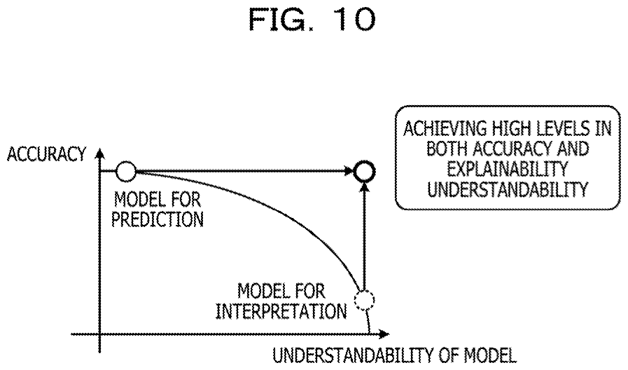

In the viewpoint of explainability of the machine learning, Embodiments 1 and 2 described above provide local explanation using the k-nearest neighbors algorithm. FIG. 10 illustrates a graph of relationships between accuracy and understandability of a machine learning model. In FIG. 10, the horizontal axis is an axis corresponding to the understandability and the understandability becomes higher, and the grounds of determination of the determination result becomes easier to present, toward the right. The vertical axis is an axis corresponding to the accuracy and the determination accuracy becomes higher toward the upper side.

In many cases, the accuracy and the understandability of the machine learning model are in a trade-off relationship. For example, although deep learning provides a determination result with high accuracy, it is difficult for a human to understand the mechanism leading to this determination result from the model. Meanwhile, the k-nearest neighbors algorithm provides a determination result with a lower accuracy than the deep learning but a human may easily understand the mechanism leading to this determination result. Accordingly, in Embodiment 3, a model for prediction and a model for explanation are prepared to achieve high levels in both accuracy and explainability of the determination result.

In this case, the searching technique BM25 may be regarded as the k-nearest neighbors algorithm in which importance degree weights of terms are changed by a given query. When a query Q including terms q₁, . . . , qₙ is given, a BM25 score of a document D is calculated by using a formula (5).

$$BM 25 score = {\sum }_{i = 1}^{n} IDF ( {q}_{i} ) \frac{TF ( {q}_{i} ) ( {k}_{1} + 1 )}{TF ( {q}_{i} ) + {k}_{1} ( 1 - b + b \frac{\vert D \vert}{avgd 1} )} \qquad ( 5 )$$

In formula (5), TF(qᵢ) indicates a value acquired by dividing the number of times of appearance of a term qᵢ included in the document D by the number of times of appearance of all terms in the document D. IDF(qᵢ) is calculated by using a formula (6). b and k₁ are parameters. avgdl is an average number of terms in documents.

IDF(qᵢ)=log(total number of documents included in document D/number of documents including term qᵢ) (6)

The aforementioned BM25 is based on an idea that, for a given data, the importance degree of consideration is different near this data.

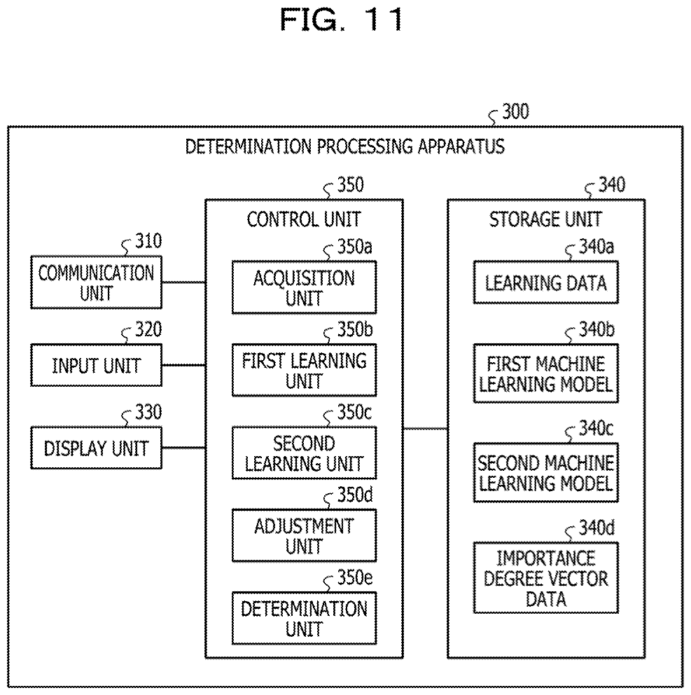

The determination processing apparatus according to Embodiment 3 calculates the importance degree vector for each piece of given data to be predicted T. FIG. 11 is a functional block diagram illustrating a configuration of the determination processing apparatus according to Embodiment 3. As illustrated in FIG. 11, the determination processing apparatus 300 includes a communication unit 310, an input unit 320, a display unit 330, a storage unit 340, and a control unit 350.

The communication unit 310 is a processing unit that performs data communication with an external device (not illustrated) via a network. The communication unit 310 is an example of the communication device. The determination processing apparatus 300 may acquire learning data 340a to be described later from the external device.

The input unit 320 is an input device used to input a variety of information to the determination processing apparatus 300. For example, the input unit 320 corresponds to a keyboard, a mouse, a touch panel, and the like. The user may input the data to be predicted by operating the input unit 320.

The display unit 330 is a display device that displays information outputted from the control unit 350. For example, the information outputted from the control unit 350 includes information in which a determination result for the data to be predicted is associated with the grounds of the determination result. The display unit 330 corresponds to a liquid crystal display, an organic EL display, a touch panel, and the like.

The storage unit 340 includes the learning data 340a, a first machine learning model 340b, a second machine learning model 340c, and an importance degree vector data 340d. The storage unit 340 corresponds to a semiconductor memory element such as a RAM and a flash memory, or a storage device such as an HDD.

The learning data 340a is data in which pieces of training data are associated with labels. A data structure of the learning data 340a is similar to the data structure of the learning data 140a described in FIG. 2 and description thereof is thus omitted. A data structure of the training data is similar to the data structure of the training data described in FIG. 3.

The first machine learning model 340b is a learning model trained by ensemble learning. Description of the first machine learning model 340b is similar to the description of the first machine learning model 140b explained in FIG. 4. The first machine learning model 340b outputs the determination result for the inputted data and the confidence factor of the determination result. The determination result is “recognized” or “not recognized”.

The second machine learning model 340c is a model that outputs a determination result of “recognized” or “not recognized” by using the k-nearest neighbors algorithm. For example, the second machine learning model 340c associates each piece of weighted training data with a corresponding one of the labels of the respective pieces of training data. When the second machine learning model 340c outputs the determination result, the second machine learning model 340c outputs the confidence factor of the determination result together with the determination result.

The importance degree vector data 340d indicates the importance degrees of the respective feature amounts included in the data (training data, data to be predicted). The importance degrees of the respective feature amounts are determined in a process of training the first machine learning model 340b. The importance degree vector w is defined by the formula (1).

The control unit 350 includes an acquisition unit 350a, a first learning unit 350b, a second learning unit 350c, an adjustment unit 350d, and a determination unit 350e. The control unit 350 may be achieved by a CPU, an MPU, or the like. The control unit 350 may also be achieved by hard-wired logic such as ASIC and FPGA.

The acquisition unit 350a is a processing unit that acquires the learning data 340a from the external device (not illustrated) or the like. The acquisition unit 350a stores the acquired learning data 340a in the storage unit 340. When the acquisition unit 350a acquires the data to be predicted, the acquisition unit 350a outputs the data to be predicted to the determination unit 350e.

The acquisition unit 350a compares the data to be predicted and the data set D included in the learning data 340a and samples pieces of training data in a neighborhood of the data to be predicted among the pieces of training data included in the data set D. The neighborhood of the data to be predicted is set as an area within a predetermined range from the position of the data to be predicted. The acquisition unit 350a describes a set of the pieces of sampled training data as data set Z.

The acquisition unit 350a outputs information (hereafter, referred to as neighborhood learning data) in which the data set Z is associated with labels of the respective pieces of training data included in the data set Z, to the first learning unit 350b and the second learning unit 350c. The acquisition unit 350a outputs information on the data set Z to the adjustment unit 350d.

The first learning unit 350b is, for example, a processing unit that executes the ensemble learning based on the neighborhood learning data to generate the first machine learning model 340b. When the first machine learning model 340b includes the three decision trees 31a to 31c, the first learning unit 350b divides the neighborhood learning data into three pieces and learns each of the decision trees 31a to 31c based on a corresponding one of the divided pieces of neighborhood learning data. The processing of the first learning unit 350b learning the decision trees 31 is similar to that of the first learning unit 150b described in Embodiment 1.

Note that the first learning unit 350b adjusts the importance degree vector w by cooperating with the adjustment unit 350d to be described later.

The second learning unit 350c is a processing unit that generates the second machine learning model 340c based on the neighborhood learning data. For example, the second learning unit 350c calculates a product “wZ” of the importance degree vector w and the data set Z of training data included in the neighborhood learning data.

The second learning unit 350c generates the second machine learning model 340c by associating the positions of the respective pieces of weighted training data (training data is the training data included in the data set Z) with the labels of the respective pieces of training data (before the weighting).

The adjustment unit 350d is a processing unit that adjusts the importance degree vector w based on a determination result acquired when the data set Z is inputted into the first machine learning model 340b and a determination result acquired when the product wZ of the data set Z and the importance degree vector w is inputted into the second machine learning model 240c. The adjustment unit 350d updates the importance degree vector data 340d by using the adjusted importance degree vector w.

The determination result acquired when the data set Z is inputted into the first machine learning model 340b corresponds to the first determination result. The determination result acquired when the product wZ is inputted into the second machine learning model 340c corresponds to the second determination result. The adjustment unit 350d searches for the importance degree vector w that minimizes the difference between the confidence factor of the first determination result and the confidence factor of the second determination result.

The adjustment unit 350d adjusts the importance degree vector w such that a value of an objective function of a formula (7) is minimized. The formula (7) is a formula in which the difference between M(Z) and K(wZ) is minimized. The objective function to be minimized is a norm (Frobenius norm) of a matrix.

$${min}_{w ∈ {R}^{a}} {‖ M ( Z ) - K ( wZ ) ‖}_{F} \qquad ( 7 )$$

In the formula (7), M(Z) Indicates a matrix of prediction probabilities (confidence factors of the respective labels) outputted when the pieces of training data d included in the data set Z are inputted into the first machine learning model 340b.

k(wZ) indicates a matrix of prediction probabilities outputted when the pieces of training data wd included in the product wZ are inputted into the second machine learning model 340c.

For example, the adjustment unit 350d searches for the importance degree vector w that minimizes the objective function of the formula (7) by repeatedly executing processing of updating the importance degree vector w and updating the decision trees 31 of the first machine learning model 340b according to the updated importance degree vector w to acquire the value of the formula (7) while cooperating with the first learning unit 350b. The adjustment unit 350d may use any search method and, for example, may use “hyperopt” that is a black box optimization.

The determination unit 350e is a processing unit that predicts the determination result for the data to be predicted. The determination unit 350e uses the first machine learning model 340b as a model used to predict the determination result. The determination unit 350e uses the second machine learning model 340c as a model for interpretation used to determine the similar data that is the grounds of determination of the determination result.

The processing of the determination unit 350e predicting the determination result for the data to be predicted is described. The determination unit 350e inputs the data to be predicted into the first machine learning model 340b and acquires the determination result outputted from the first machine learning model 340b.

The processing of the determination unit 350e determining the similar data that is the grounds of determination of the determination result is described. The determination unit 350e calculates the “weighted data” based on the formula (3) described in Embodiment 1.

The determination unit 350e calculates the distance between the weighted data and each piece of weighted training data and sorts the pieces of weighted training data in the ascending order of distance to the weighted data. The determination unit 350e selects k pieces of weighted training data from the top. The determination unit 350e determines the training data before the multiplication of the importance degree vector that corresponds to the selected weighted training data, as the data similar to the data to be predicted (similar data).

The determination unit 350e associates the determination result of the first machine learning model 340b with the information being the grounds of determination and outputs the determination result and the information to the display unit 330 to cause it to display the determination result and the information. The information being the grounds of determination is the aforementioned similar data.

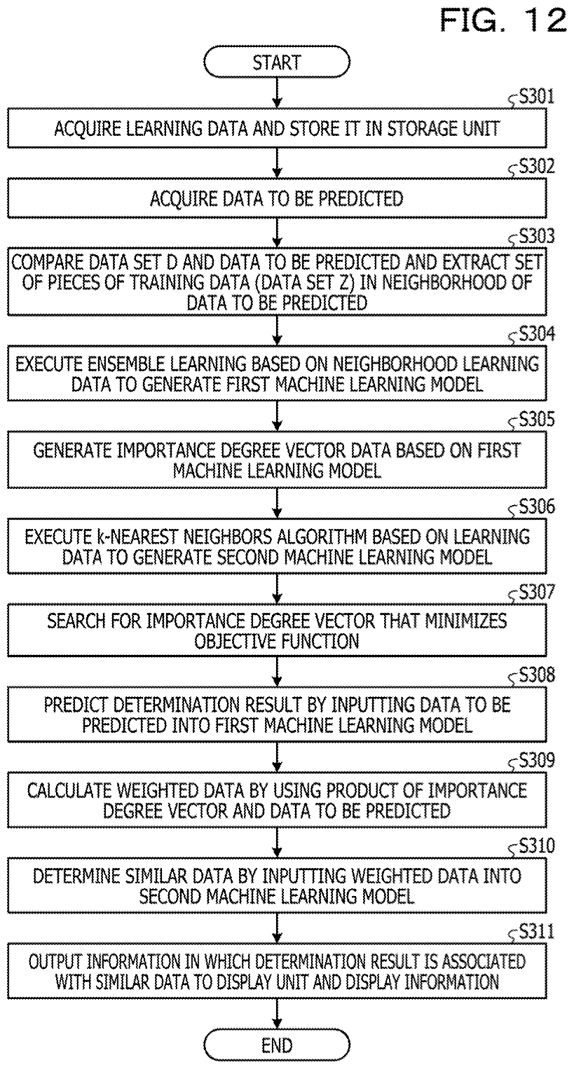

Next, an example of a processing procedure of the determination processing apparatus 300 according to Embodiment 3 is described. FIG. 12 is a flowchart illustrating the processing procedure of the determination processing apparatus according to Embodiment 3. As illustrated in FIG. 12, the acquisition unit 350a of the determination processing apparatus 300 acquires the learning data 340a and stores the learning data 340a in the storage unit 340 (step S301), The acquisition unit 350a acquires the data to be predicted (step S302). The acquisition unit 350a compares the data set D and the data to be predicted and extracts a set (data set Z) of pieces of training data in the neighborhood of the data to be predicted (step S303).

The first learning unit 350b of the determination processing apparatus 300 executes the ensemble learning based on the neighborhood learning data to generate the first machine learning model 340b (step S304). The first learning unit 350b generates the importance degree vector data 340d based on the first machine learning model 340b (step S305).

The second learning unit 350c of the determination processing apparatus 300 executes the k-nearest neighbors algorithm based on the neighborhood learning data to generate the second machine learning model 340c (step S306). In step S306, the second learning unit 350c generates the second machine learning model 340c by using the product “wZ” of the data set Z and the importance degree vector w.

The adjustment unit 350d of the determination processing apparatus 300 searches for the importance degree vector that minimizes the objective function of the formula (7) (step S307). The determination unit 350e of the determination processing apparatus 300 predicts the determination result by inputting the data to be predicted into the first machine learning model 340b (step S308).

The determination unit 350e calculates the weighted data by using the product of the importance degree vector and the data to be predicted (step S309). The determination unit 350e determines the similar data by inputting the weighted data into the second machine learning model (step S310). The determination unit 350e outputs the information in which the determination result is associated with the similar data (information being the grounds of the determination result) to the display unit 330 to cause it to display the information (step S311).

Next, effects of the determination processing apparatus 300 according to Embodiment 3 are described. The determination processing apparatus 300 samples the pieces of training data present in the neighborhood of the data to be predicted among the pieces of training data included in the data set D to extract the data set Z. The determination processing apparatus 300 adjusts the importance degree vector such that the difference between the determination result acquired when the data set Z is inputted into the first machine learning model 340b and the determination result acquired when w*Z is inputted into the second machine learning model 340c is minimized. The importance degree vector may be thereby adjusted based on the training data in the neighborhood of the data to be predicted.

The determination processing apparatus 300 uses the first machine learning model 340b as the model used to predict the determination result and uses the second machine learning model 340c as a model for interpretation used to determine the similar data that is the grounds of determination of the determination result. This may improve the accuracy of determination result while allowing presentation of the grounds of the determination result.

Next, an example of a hardware configuration of a computer that achieves functions similar to those of the determination processing apparatus 100 (200, 300) described in the aforementioned embodiment is described element by element.

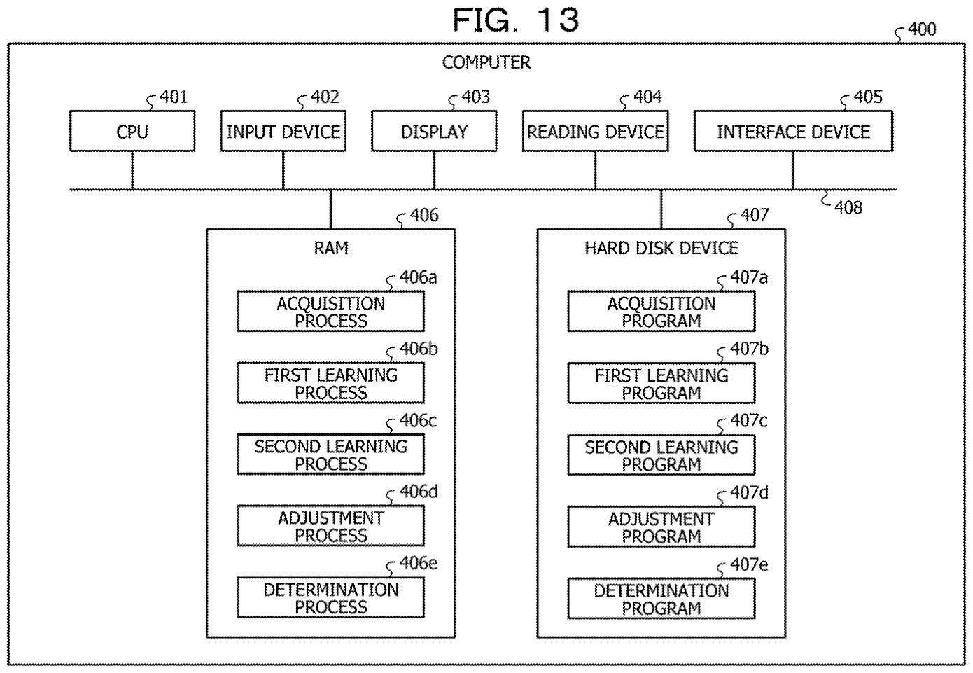

FIG. 13 illustrates a diagram of an example of the hardware configuration of the computer that achieves functions similar to those of the determination processing apparatus. As illustrated in FIG. 13, the computer 400 includes a CPU 401 that executes various arithmetic processing, an input device 402 that receives input of data from the user, a display 403, and a reading device 404. The computer 400 also includes an interface device 405 that exchanges data with an external device via a network. The computer 400 includes a RAM 406 that temporarily stores a variety of information, and a hard disk device 407. The devices 401 to 407 are coupled to a bus 408.

The hard disk device 407 includes an acquisition program 407a, a first learning program 407b, a second learning program 407c, an adjustment program 407d, and a determination program 407e. The CPU 401 reads the acquisition program 407a, the first learning program 407b, the second learning program 407c, the adjustment program 407d, and the determination program 407e and develops these programs in the RAM 406.

The acquisition program 407a functions as an acquisition process 406a. The first learning program 407b functions as a first learning process 406b. The second learning program 407c functions as a second learning process 406c. The adjustment program 407d functions as an adjustment process 406d. The determination program 407e functions as a determination process 406e.

Processing in the acquisition process 406a corresponds to the processing of each of the acquisition units 150a, 250a, and 350a. Processing in the first learning process 406b corresponds to the processing of each of the first learning units 150b, 250b, and 350b. Processing in the second learning process 406c corresponds to the processing of each of the second learning units 150c, 250c, and 350c. Processing in the adjustment process 406d corresponds to the processing of each of the adjustment units 250d and 350d. Processing in the determination process 406e corresponds to the processing of each of the determination units 150d, 250e, and 350e.

The programs 407a to 407e do not have to be stored in the hard disk device 407 from the beginning. For example, the programs may be stored in a “portable physical medium” to be inserted into the computer 400, such as a flexible disk (FD), a compact disc read-only memory (CD-ROM), a digital versatile disc (DVD), a magneto-optical disc, and an IC card. The computer 400 may read and execute the programs 407a to 407e.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium for storing a determination processing program which causes a processor to perform processing, the processing comprising:
obtaining an importance degree vector for a plurality of feature amounts by training a first machine learning model based on machine-learning data, the machine-learning data including pieces of training data, each of the pieces of training data including the plurality of feature amounts and being associated with a corresponding determination result;
training a second machine learning model of a k-nearest neighbors algorithm in accordance with the machine-learning data and the importance degree vector; and
determining, from among the pieces of training data, a piece of data that is similar to data to be predicted, by using the trained second machine learning model and the data to be predicted.

2. The non-transitory computer-readable storage medium according to claim 1, wherein
the determining is configured to
obtain an input value by multiplying the importance degree vector by the data to be predicted, and
determine the piece of similar data by inputting the input value into the second machine learning model, and
the processing further comprises
outputting the piece of similar data and a determination result in association with each other, the determination result being a result obtained by inputting the data to be predicted into the first machine learning model.

3. The non-transitory computer-readable storage medium according to claim 1, the processing further comprising:
adjusting the importance degree vector such that a difference between a confidence factor of a first determination result and a confidence factor of a second determination result is minimized, the first determination result being a determination result obtained by inputting the pieces of training data into the first machine learning model, the second determination result being a determination result obtained by inputting pieces of corrected training data into the second machine learning model, the pieces of corrected training data being obtained by correcting the plurality of feature amounts in the pieces of training data with the importance degree vector.

4. The non-transitory computer-readable storage medium according to claim 3, the processing further comprising
extracting, from the pieces of training data included in the machine-learning data, a first data set including more than one of the pieces of training data present in a neighborhood of the data to be predicted, and
wherein the adjusting is configured to adjust the importance degree vector based on a determination result obtained by inputting the first data set into the first machine learning model and a determination result obtained by inputting a second data set into the second machine learning model, the second data set being obtained by multiplying the plurality of feature amounts in the first data set by the importance degree vector.

5. A determination processing apparatus, comprising:
a memory; and
a processor coupled to the memory, the processor being configured to execute processing, the processing including:
obtaining an importance degree vector for a plurality of feature amounts by training a first machine learning model based on machine-learning data, the machine-learning data including pieces of training data, each of the pieces of training data including the plurality of feature amounts and being associated with a corresponding determination result;
training a second machine learning model of a k-nearest neighbors algorithm in accordance with the machine-learning data and the importance degree vector; and
determining, from among the pieces of training data, a piece of data that is similar to data to be predicted, by using the trained second machine learning model and the data to be predicted.

6. The determination processing apparatus according to claim 5, wherein
the determining is configured to
obtain an input value by multiplying the importance degree vector by the data to be predicted, and
determine the piece of similar data by inputting the input value into the second machine teaming model, and
the processing further comprises
outputting the piece of similar data and a determination result in association with each other, the determination result being a result obtained by inputting the data to be predicted into the first machine learning model.

7. The determination processing apparatus according to claim 5, the processing further comprising:
adjusting the importance degree vector such that a difference between a confidence factor of a first determination result and a confidence factor of a second determination result is minimized, the first determination result being a determination result obtained by inputting the pieces of training data into the first machine learning model, the second determination result being a determination result obtained by inputting pieces of corrected training data into the second machine learning model, the pieces of corrected training data being obtained by correcting the plurality of feature amounts in the pieces of training data with the importance degree vector.

8. The determination processing apparatus according to claim 7, the processing further comprising
extracting, from the pieces of training data included in the machine-learning data, a first data set including more than one of the pieces of training data present in a neighborhood of the data to be predicted, and
wherein the adjusting is configured to adjust the importance degree vector based on a determination result obtained by inputting the first data set into the first machine learning model and a determination result obtained by inputting a second data set into the second machine learning model, the second data set being obtained by multiplying the plurality of feature amounts in the first data set by the importance degree vector.

9. A determination processing method implemented by a computer, the method comprising:
obtaining an importance degree vector for a plurality of feature amounts by training a first machine learning model based on machine-learning data, the machine-learning data including pieces of training data, each of the pieces of training data including the plurality of feature amounts and being associated with a corresponding determination result;
training a second machine learning model of a k-nearest neighbors algorithm in accordance with the machine-learning data and the importance degree vector; and
determining, from among the pieces of training data, a piece of data that is similar to data to be predicted, by using the trained second machine learning model and the data to be predicted.

10. The determination processing method according to claim 9,
the determining being configured to
obtain an input value by multiplying the importance degree vector by the data to be predicted, and
determine the piece of similar data by inputting the input value into the second machine learning model, and
the method further comprising
outputting the piece of similar data and a determination result in association with each other, the determination result being a result obtained by inputting the data to be predicted into the first machine learning model.

11. The determination processing method according to claim 9, the method further comprising:
adjusting the importance degree vector such that a difference between a confidence factor of a first determination result and a confidence factor of a second determination result is minimized, the first determination result being a determination result obtained by inputting the pieces of training data into the first machine learning model, the second determination result being a determination result obtained by inputting pieces of corrected training data into the second machine learning model, the pieces of corrected training data being obtained by correcting the plurality of feature amounts in the pieces of training data with the importance degree vector.

12. The determination processing method according to claim 11, the method further comprising
extracting, from the pieces of training data included in the machine-learning data, a first data set including more than one of the pieces of training data present in a neighborhood of the data to be predicted,
wherein the adjusting is configured to adjust the importance degree vector based on a determination result obtained by inputting the first data set into the first machine learning model and a determination result obtained by inputting a second data set into the second machine learning model, the second data set being obtained by multiplying the plurality of feature amounts in the first data set by the importance degree vector.
